(19) United States
(12) Patent Application Publication
(10) Pub. No.: US 2012/0044182 A1
(43) Pub. Date: Feb. 23, 2012

(54) Touch Panel and Flat Panel Display Device Having the Same

(76) Inventors: Sang-Woo SEO, Daegu (KR); Bo-Sun LEE, Cheongju (KR)

(21) Appl. No.: 13/214,381

(22) Filed: Aug. 22, 2011

(30) Foreign Application Priority Data
Aug. 20, 2010 (KR) 10-2010-0080984

(51) Int. Cl. G06F 3/041

(52) U.S. Cl. 345/173

(57) ABSTRACT

A touch panel may have lower electrodes formed thereon each with a preset inclination, which allows fabrication of a touch panel with high transmittance, and implementation of a high-quality screen upon driving a flat panel display device having the touch panel. The touch panel includes an insulating substrate, a plurality of lower electrodes formed on the substrate, each of the lower electrodes having a preset inclination, an insulating layer formed on the lower electrodes and having a plurality of contact holes for partially exposing the plurality of lower electrodes, a plurality of upper electrodes formed on the insulating layer and electrically connected to the plurality of lower electrodes via the plurality of contact holes, and a passivation layer formed on the upper electrodes.

### CROSS-REFERENCE TO RELATED APPLICATION

This application claims the benefit of Korean Patent Application No. 10-2010-0080984, filed on Aug. 20, 2010, which is hereby incorporated by reference for all purposes in its entirety.

### BACKGROUND OF THE INVENTION

1. Field of the Invention

This specification relates to a touch panel and a flat panel display device having the same, and particularly, to a touch panel with high transmittance, capable of implementing a high-resolution screen upon driving a flat panel display device having the touch panel, and a flat panel display device having the same.

2. Background of the Invention

A display device is a visual information transfer medium, which visually displays data on a cathode ray tube (CRT) screen in form of characters or figures.

In general, a flat panel display (FPD) device is an image display device, which is thin in thickness and light in weight, and there are various types of FPD devices, such as a liquid crystal display (LCD) using liquid crystal, a plasma display panel (PDP) using gas discharging, an organic light emitting diode (OLED) display using a fluorescent organic compound which emits light when a current flows on the compound.

Meanwhile, a touch panel, which is aligned on the FPD device and can be pressed by a user with a finger or a pen to input a corresponding command, has been developed.

The touch panel is already being widely applied, starting from automated teller machines (ATM) of banks to portable information devices, such as portable digital assistants (PDA), notebook computers, tablet PCs and the like. In general, the LCD is most frequently used as the FPD device to be attached onto the touch panel.

The touch panels may be categorized according to a method for detecting a touch depending on a resistive type, a capacitive type, an electromagnetic type and the like.

Among the various types of touch panels, the capacitive type touch panel is configured such that when a finger or a conductor such as a pen is located in the vicinity of an upper glass substrate or touches the substrate, a voltage drop is generated and thus the touch position is detected by the change in the voltage.

The capacitive type touch panel has no air layer in the middle, unlike the resistive type touch panel, and is able to remarkably suppress reflectivity generated at an interface. Also, the capacitive type touch panel has a structure, in which interference non-uniformity (Newton ring) or glittering is rarely caused, resulting in high optical properties.

FIG. 1 is a planar view of a capacitive type touch panel according to the related art, FIG. 2 is a sectional view taken along the line I-I′ of FIG. 1. FIG. 3A shows the fabricated state of the related art capacitive type touch panel, and FIG. 3B shows a magnified view of part A in FIG. 3a.

Referring to FIGS. 1 and 2, the capacitive type touch panel includes a plurality of lower electrodes 30 on an insulating substrate 10. Here, the lower electrodes 30 are horizontally aligned with being spaced apart from one another by preset intervals, and each has a rectangular shape.

An insulating layer 50 is formed on the lower electrodes 30. Here, the insulating layer 50 is interposed between the lower electrodes 30 and upper electrodes 70 for insulation therebetween.

First and second contact holes 53 and 55 are formed through the insulating layer 50 to partially expose the lower electrodes 30. The upper electrodes 70 are formed on the insulating layer 50. Here, the lower electrodes 30 and the upper electrodes 70 are electrically connected to each other via the first and second contact holes 53 and 55.

Here, the upper electrode 70 may be provided in plurality, and each includes a first upper electrode 72 and a second upper electrode 76. The first upper electrode 72 is formed in a lozenge-shaped pattern. The lozenge-shaped first upper electrodes 72 of the upper electrodes 70 are connected together by upper connecting portions 74, which are provided for connection among the lozenge-shaped first upper electrodes 72. On the other hand, the second upper electrodes 76 of the upper electrodes 70 are also formed in the same lozenge-shaped patterns as the first upper electrodes 72, but spaced apart from one another by preset intervals.

Here, the lower electrode 30 and the upper electrode 70 may be formed of a conductive polymer, such as indium tin oxide (ITO), which is transparent and conductive or a metal.

Referring to FIG. 2, a passivation layer 90 for protecting the upper electrodes 70 from the exterior is formed on the upper electrodes 70.

As shown in FIGS. 3A and 3B, upon viewing the related art capacitive type touch panel 100, formed of the lower electrode 30 and the upper electrode 70 made of metals, with the naked eyes, shadows of the lower electrodes 30 are visibly formed in the horizontal direction. Specifically, for example, when the lower electrode 30 covers a significant portion (e.g. 100%, 99%, 98%, 97%, 96%, 95%, 93%, 90%) of the subpixels (SP1, SP2, SP3) under the touch panel (100), the light transmitted from the subpixels is reflected on the metal lower electrode (30) and sufficient light does not get transmitted to the front surface, resulting in the shadows. These shadow lowers transmittance of the touch panel. Consequently, when an FPD device having such a touch panel with the shadow is in operation, the quality of the screen is degraded.

### SUMMARY OF THE INVENTION

Therefore, to address such problems of a capacitive type touch panel described above, one aspect of the detailed description is to provide a touch panel, which is allowed to have high transmittance by forming lower electrodes, each having a preset inclination and capable of implementing a high-resolution screen upon driving a flat panel display device having the touch panel, and a flat panel display device having the same.

To achieve these and other advantages and in accordance with the purpose according to one aspect of the invention, as embodied and broadly described herein, a touch panel may include an insulating substrate, a plurality of lower electrodes formed on the substrate, each of the lower electrodes having a preset inclination, an insulating layer formed on the lower electrodes and having a plurality of contact holes for partially exposing the plurality of lower electrodes, a plurality of upper electrodes formed on the insulating layer and electrically connected to the plurality of lower electrodes via the plurality of contact holes, and a passivation layer formed on the upper electrodes.

In some embodiments, the lower electrodes may be spaced apart from one another with preset intervals.

In further embodiments, the upper electrodes may include first upper electrodes, each having a lozenge-shaped pattern and connected to one another by connecting portions, and second upper electrodes, each having a lozenge-shaped pattern and present between the connecting portions, where the second upper electrodes are spaced apart with preset intervals.

In yet further embodiments, the interval between the second upper electrodes may be in the range of 50 μm to 90 μm.

In additional embodiments, the interval between the connecting portion of the first upper electrode and the second upper electrode may be in the range of 8 μm to 12 μm. The width of the connecting portion may be in the range of 40 μm to 60 μm. The inclination of the lower electrode may be in the range of 5° to 40°. The length of the lower electrode may be in the range of 120 μm to 560 μm. The width of the lower electrode may be in the range of 3 μm to 5 μm.

In yet additional embodiments, the inclination of the lower electrode may differ depending on resolution of a flat panel display device. The number of lower electrodes may differ depending on the resolution of the flat panel display device and/or on the number of channels in the touch panel chip (IC) of Flexible Printed Circuit (FPC).

In accordance with one exemplary embodiment, a flat panel display device may include a touch panel described herein.

In accordance with another exemplary embodiment, a flat panel display device may include a touch panel including a plurality of lower electrodes formed on an insulating substrate, each of the lower electrodes having a preset inclination, an insulating layer formed on the lower electrodes and having a plurality of contact holes for partially exposing the plurality of lower electrodes, a plurality of upper electrodes formed on the insulating layer and electrically connected to the plurality of lower electrodes via the plurality of contact holes, and a passivation layer formed on the upper electrodes, an organic light emitting diode layer located below the touch panel, an array substrate located below the organic light emitting diode layer, and a polarizer for organic light emitting diode located on the touch panel.

In additional embodiments, the polarizer for organic light emitting diode may include a phase delay film. The pixels formed on the array substrate may be smaller than the lower electrodes.

As described above, in accordance with the touch panel and the flat panel display device, each of lower electrodes on the touch panel can have a preset inclination, thereby fabricating a touch panel having high transmittance, and also a high-resolution screen can be implemented upon driving the flat panel display device having the touch panel.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings are included to provide a further understanding of the invention and are incorporated in and constitute a part of this specification. The drawings illustrate exemplary embodiments and together with the description serve to explain the principles of the invention. In the drawings:

FIG. 1 is a planar view of a capacitive type touch panel according to the related art;

FIG. 2 is a sectional view taken along the line I-I′ of FIG. 1;

FIG. 3A shows the fabricated state of the related art capacitive type touch panel;

FIG. 3B shows a magnified view of part A in FIG. 3a;

FIG. 4 is a sectional view showing an FPD device having a capacity type touch panel in accordance with one exemplary embodiment;

FIG. 5 is a sectional view showing the capacitive type touch panel in accordance with one exemplary embodiment;

FIG. 6 is a planar view showing patterns of lower electrodes of FIG. 5;

FIG. 7 is a table showing the experimental data with various sizes and angles of lower electrodes;

FIG. 8 is the planar view of the subpixels according to one exemplary embodiment;

FIG. 9 is a planar view showing patterns of upper electrodes of FIG. 5;

FIG. 10 is a planar view showing an overlapped state between the patterns of the lower electrodes and the upper electrodes according to one exemplary embodiment;

FIG. 11 is an enlarged view of part A of FIG. 8; and

FIG. 12 is a sectional view of an organic light emitting layer of FIG. 4.

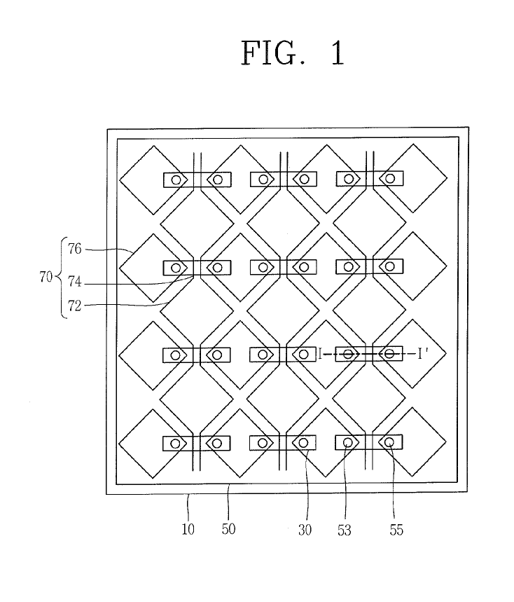

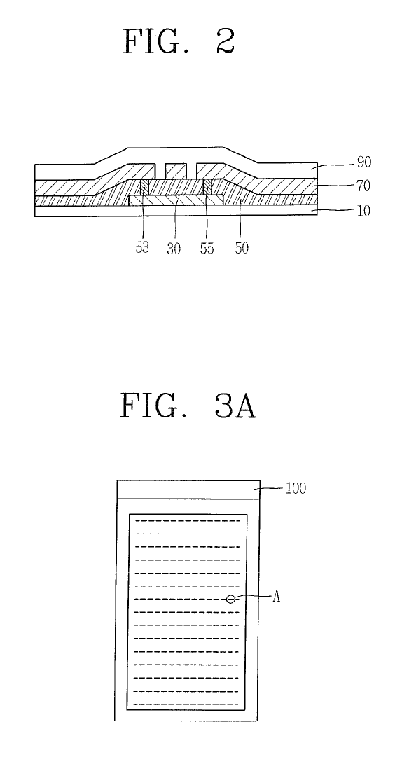

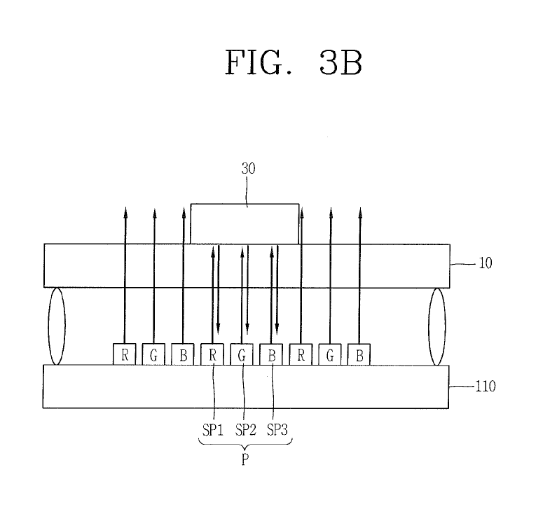

### DETAILED DESCRIPTION OF THE INVENTION

Description will now be given in detail of a touch panel and a flat panel display (FPD) device having the same according to the exemplary embodiments, with reference to the accompanying drawings. For the sake of brief description with reference to the drawings, the same or equivalent components will be provided with the same reference numbers, and description thereof will not be repeated.

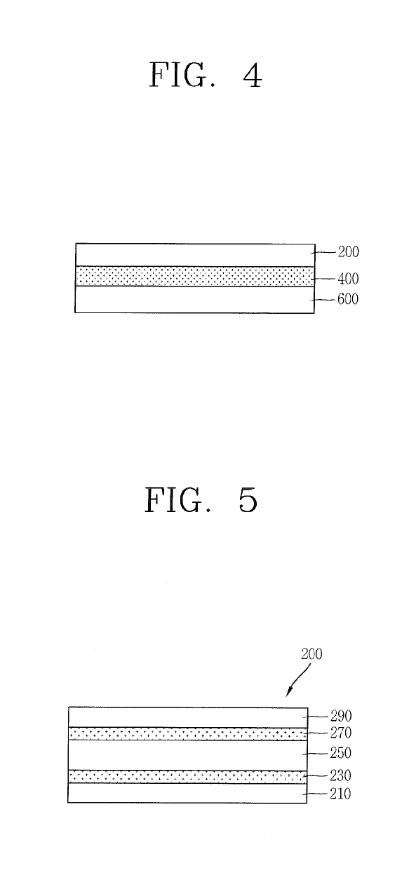

Referring to FIG. 4, an FPD device in accordance with one exemplary embodiment may include an organic light emitting diode (OLED) layer 400 formed on an array substrate 600, and a touch panel 200 formed on the OLED layer 400 and configured as a capacitive type, which will now be described in detail with reference to FIGS. 5 to 11.

Referring to FIG. 5, the capacitive type touch panel 200 according to the one exemplary embodiment may include an insulating substrate 210, a lower electrode 230 on the insulating substrate 210, an insulating layer 250 on the lower electrode 230, an upper electrode 270 on the insulating layer 250, and a passivation layer 290 on the upper electrode 270.

In some embodiments, the lower electrode 230 and the upper electrode 270 may be formed of a conductive polymer, such as indium tin oxide (ITO), which is transparent and conductive.

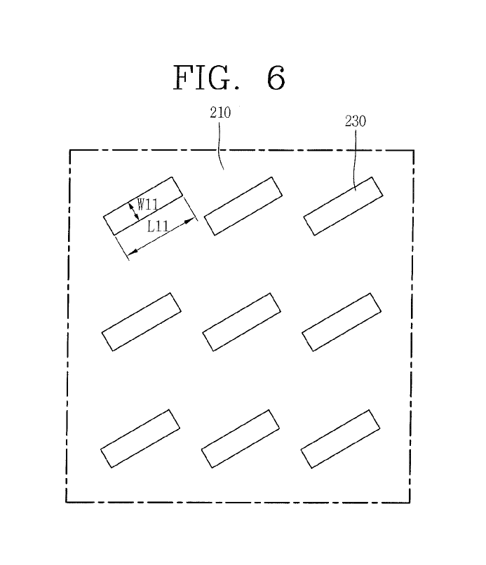

Referring to FIG. 6, the lower electrode 230 may be provided in plurality, and each may be formed in a rectangular pattern. The plurality of lower electrodes 230 may be disposed with being spaced apart from one another by preset intervals. Also, in this exemplary embodiment, in order to fabricate a touch panel having high transmittance and to implement a high-resolution screen upon driving an FPD device having the touch panel, each of the lower electrodes 230 may have a preset inclination.

In some embodiments, the inclination of the lower electrode 230 may be in any range or in the range of 5° to 40°. The inclination of the lower electrode 230 may differ depending on resolution of the FPD device. Also, a length L11 of the lower electrode 230 may be, for example, in the range of 120 μm to 600 μm, and a width W11 of the lower electrode 230 may be as narrow as possible as further described below.

When the lower electrodes 230 are formed in a horizontal direction, upon driving the FPD device having the touch panel, the lower electrodes 230 may overlap part of pixels to thereby make shadows, which are visible to the naked eyes, thereby lowering the transmittance of the touch panel. Hence, to address the problem, the lower electrodes 230 having the structure described herein is proposed.

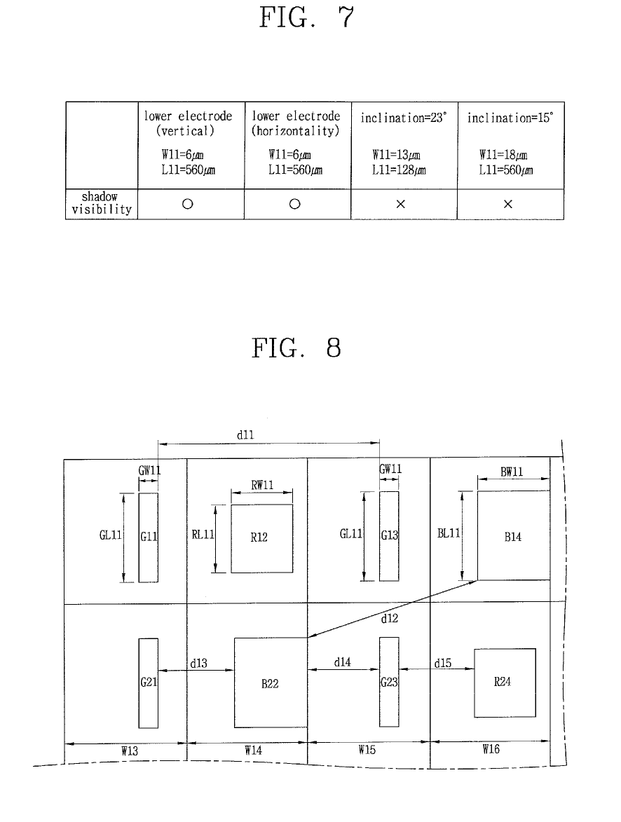

FIG. 7 provides experimental data using exemplary touch panels with the various angles of lower electrodes 230 at vertical, horizontal, 23°, and 15° angles. In the cases where the lower electrodes (Width W11 6 μm; Length L11 560 μm) were aligned vertically or horizontally, the shadows of the lower electrodes were visible on the touch panel with naked eyes.

On the other hand, in the case where the lower electrodes (Width W11 13 μm; Length L11 128 μm) were angled at 23°, the shadows were not visible with naked eyes. Also, in the case where the lower electrodes (Width W11 18 μm; Length L11 560 μm) were angled at 15°, the shadows again were not visible. Accordingly, the angled lower electrodes removed the shadows of the lower electrodes and thus improves the transmittance of the touch panel. Consequently, when an FPD device having such a touch panel with the angled lower electrodes is in operation, the quality of the screen is improved.

Referring to FIG. 8, in some embodiments, the touch panel can be of various size, including, but not limited to, 3.5 inch panel or 3.77 inch panel. For example, in the case of an exemplary 3.77 inch panel, a green subpixel (G11 or G13) has the width (GW11) of 15.12 μm and the length (GL11) of 81.75 μm, a red subpixel (R12 or R24) has the width (RW11) of 39.63 μm and the length (RL11) of 54.25 μm, and a blue subpixel (B14 or B22) has the width (BW11) of 39.63 μm and the length (BL11) of 80.25 μm. Moreover, the distance (d11) between one green subpixel (G11) and another green subpixel (G13) is 87.63 μm, and the distance (d12) between one blue subpixel (B22) and another blue subpixel (B14) is 67 μm. In addition, the horizontal distances between the subpixels may be uniform. Specifically, (i) the distance (d13) between a first green subpixel (G21) and another blue subpixel (B22), (ii) the distance (d14) between the blue subpixel (B22) and a second green subpixel (G23), and (iii) the distance (d15) between the second green subpixel (G23) and one red subpixel (R24) can be uniform (e.g. 24 μm). In further embodiments, the widths of subpixel areas may vary or be uniform. Specifically, the widths of subpixel areas (W13 and W15) can be 51.37 μm, and/or the widths of subpixel areas (W14 and W16) can be 51.38 μm.

In some embodiments, based on the width and length of contact holes to be formed later, the width W11 of the lower electrode 230 may be in the range of 12 μm to 18 μm, for example.

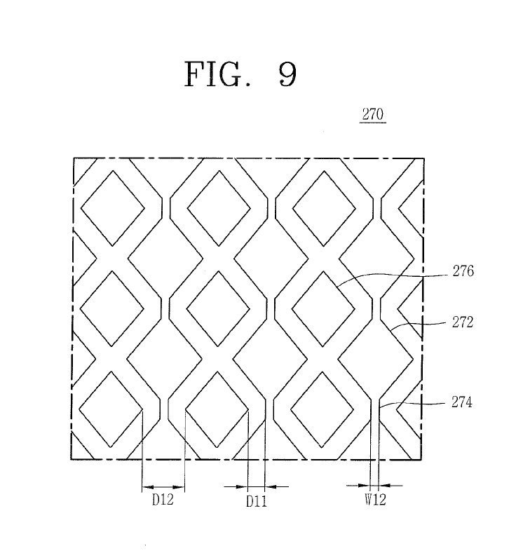

Referring to FIG. 9, the upper electrode 270 may be provided in plurality, and each may include a first upper electrode 272 and a second upper electrode 276. The first upper electrode 272 is formed in a lozenge-shaped pattern. The lozenge-shaped first upper electrodes 272 of the upper electrodes 270 are connected together by upper connecting portions 274, which are provided for connection among the lozenge-shaped first upper electrodes 272. On the other hand, the second upper electrodes 276 of the upper electrodes 270 are also formed in the same lozenge-shaped patterns as the first upper electrodes 272, but spaced apart from one another by preset intervals.

In some embodiments, a width W12 of the upper connecting portion 274 of the first upper electrode 272 may be in the range of 40 μm to 60 μm, for example. An interval D11 between the upper connecting portion 274 of the first upper electrode 272 and the second upper electrode 276 may be in the range of 8 μm to 12 μm, for example. Also, an interval D12 between the second upper electrodes 276 may be in the range of 50 μm to 90 μm, for example. μm

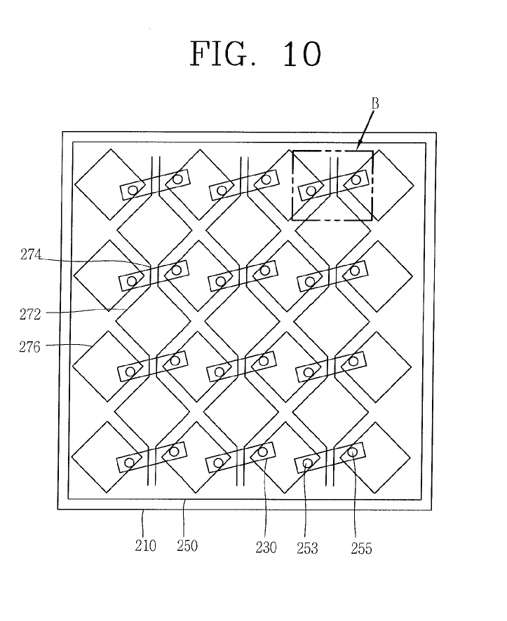

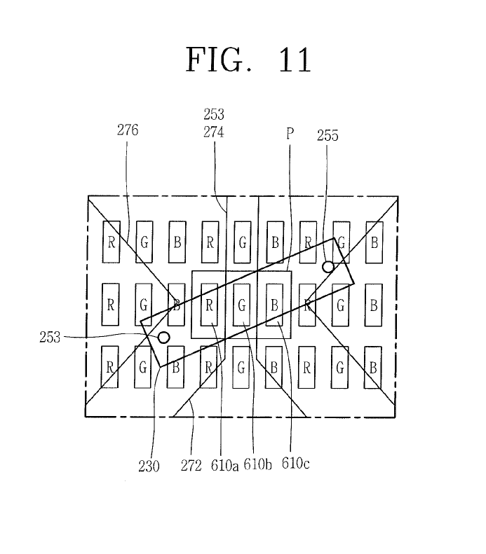

FIG. 10 shows the overlapped state between the upper and lower electrodes, and FIG. 11 shows an enlarged view of part A of FIG. 10. Here, R, G and B pixels 610a to 610c may be smaller than the lower electrodes 230. The number of lower electrodes 230 may depend on the resolution of the FPD device. For example, when the FPD device has resolution of 400×800, the number of lower electrodes 230 formed in the horizontal direction may be 10 per panel, and the number of lower electrodes 230 formed in the vertical direction may be 19 per panel. The number of lower electrodes may differ depending on the resolution of the flat panel display device and/or on the number of channels in the touch panel chip (IC) of a Flexible Printed Circuit (FPC) within the touch panel.

As described herein, the previous embodiment has exemplarily illustrated that the two contact holes are formed through the insulating layer 250 for an electric connection between the lower electrode 230 and the corresponding upper electrode 270. Alternatively, two or more contact holes may be formed through the insulating layer 250 to improve a signal transfer capability according to the resolution of the FPD device.

One exemplary embodiment has illustrated above that the lower electrode 230 is first formed on the substrate 210 and then the upper electrode 270 is formed on the insulating layer 250. Alternatively, it is also possible that the upper electrode 270 is first formed on the substrate 210 and the lower electrode 230 is formed on the insulating layer 250.

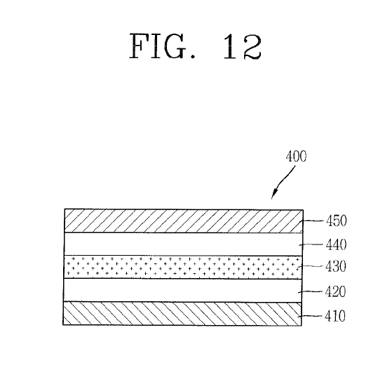

In some embodiments, as shown in FIG. 12, the OLED layer 400 may be disposed below the touch panel 200. Here, the OLED layer 400 may serve as a light source of the FPD device. The OLED layer 400 may include a hole injection layer 410, a hole transport layer 420, a light emitting layer 430 and an electron transport layer 440 and an electron injection layer 450.

In additional embodiments, the hole transport layer 420 and the electron transport layer 440 may have properties that electricity flows thereon when a high voltage is applied, and these layers may be made of a photosensitive material. The hole transport layer 420 may be made of a material including, for example, TPD, NPD, TPAC and the like. The electron transport layer 440 may be made of a material including, for example, BND, PBD, BCP and the like. In further embodiments, the light emitting layer 430 may render various colors according to luminous materials. The entire light emitting layer 430 may be made of a material having the same color. Alternatively, a part of the light emitting layer 430 may be made of a material with a different color.

In yet additional embodiments, the OLED layer 400 may have the structure of a passive matrix OLED (PMOLED).

Although not shown, an LCD (not shown) for displaying images may be disposed, for example, below the touch panel 200. In some embodiments, the LCD may include an liquid crystal (LC) panel provided with a thin film transistor (TFT) array substrate having switching devices, a color filter substrate having color filters, and an LC layer interposed between the TFT array substrate and the color filter substrate, and a backlight unit for emitting light to the LC panel.

In further embodiments, the backlight unit may include a reflection plate for guiding light emitted from a light source to a light-guiding plate and minimizing the loss of light emitted from the light source, a light-guiding plate for converting incident light from the light source into a surface light source and guiding the converted surface light source to the LC panel, optical sheets attached on the light-guiding plate, having one or more diffusion sheets and one or more prism sheets, and configured to allow incident light from a surface of the light-guiding plate to be diffused and uniformly radiated on the entire LC panel, and a light source for emitting light to the LC panel by receiving power from an external power source.

As such, in accordance with one exemplary embodiment, each lower electrode 230 is formed to have an inclination, as shown in FIG. 11, and the R, G and B subpixels 610a to 610c are formed smaller than the lower electrodes 230, thereby minimizing an overlapped area between the lower electrodes 230 and the pixels. In addition, the subpixels can be exposed by forming the lower electrodes 230 in an angle, not parallel to the subpixels, and the light from the subpixels may still be transmitted to the surface of the touch panel. Accordingly, the touch panel with sufficiently angled lower electrodes does not result in visible shadows of the lower electrodes.

In addition, in one exemplary embodiment, as shown in FIG. 4, where the OLED layer 400 is disposed below the touch panel 200, when employing a polarizer (not shown) for OLED having a phase delay film on the touch panel 200, the overlapped area between the lower electrode 230 and the pixel can be minimized. Moreover, the visibility of the touch panel 200 can be enhanced by virtue of the polarizer for OLED employed on the touch panel 200, resulting in improvement of transmittance of the touch panel 200. Consequently, a high resolution screen can be implemented upon driving the FPD device having the touch panel 200.

One exemplary embodiment has illustrated the lower electrodes formed in the horizontal direction. The present disclosure, however, is not limited thereto, and is also applicable to lower electrodes formed in the vertical direction.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A touch panel comprising:
an insulating substrate;
a plurality of lower electrodes formed on the substrate, each of the lower electrodes having a preset inclination;
an insulating layer formed on the lower electrodes and having a plurality of contact holes for partially exposing the plurality of lower electrodes; and
a plurality of upper electrodes formed on the insulating layer and electrically connected to the plurality of lower electrodes via the plurality of contact holes.

2. The touch panel of claim 1, wherein the lower electrodes are spaced apart from one another with preset intervals.

3. The touch panel of claim 1, wherein the upper electrodes comprise:
first upper electrodes each having a lozenge-shaped pattern, and connected to one another by connecting portions; and
second upper electrodes each having a lozenge-shaped pattern and present between the connecting portions, the second upper electrodes spaced apart with preset intervals.

4. The touch panel of claim 3, wherein the interval between the second upper electrodes is in the range of 50 μm to 90 μm.

5. The touch panel of claim 3, wherein the interval between (i) the connecting portion of the first upper electrode and (ii) the second upper electrode is in the range of 8 μm to 12 μm.

6. The touch panel of claim 3, wherein the width of the connecting portion is in the range of 40 μm to 60 μm.

7. The touch panel of claim 1, wherein the inclination of the lower electrode is in the range of 5° to 40°.

8. The touch panel of claim 1, wherein the length of the lower electrode is in the range of 120 μm to 560 μm.

9. The touch panel of claim 1, wherein the width of the lower electrode is in the range of 12 μm to 18 μm.

10. The touch panel of claim 1, wherein the inclination of the lower electrode differs depending on resolution of a flat panel display device.

11. The touch panel of claim 1, wherein the touch panel further comprises a Flexible Printed Circuit (FPC), the FPC comprises a touch panel chip (IC), and the number of the lower electrode differs depending on the number of channels in a touch panel chip (IC).

12. The touch panel of claim 1, wherein the number of lower electrodes differs depending on resolution of the flat panel display device.

13. The touch panel of claim 1, wherein the touch panel further comprises a passivation layer formed on the upper electrodes.

14. A flat panel display device comprising the touch panel according to claim 1.

15. A flat panel display device comprising:
a touch panel including a plurality of lower electrodes formed on an insulating substrate, each of the lower electrodes having a preset inclination, an insulating layer formed on the lower electrodes and having a plurality of contact holes for partially exposing the plurality of lower electrodes, and a plurality of upper electrodes formed on the insulating layer and electrically connected to the plurality of lower electrodes via the plurality of contact holes;
an organic light emitting diode layer located below the touch panel;
an array substrate located below the organic light emitting diode layer; and
a polarizer for organic light emitting diode located on the touch panel.

16. The device of claim 15, wherein the polarizer for organic light emitting diode comprises a phase delay film.

17. The device of claim 15, wherein the pixels formed on the array substrate are smaller than the lower electrodes.

18. The device of claim 15, wherein the touch panel further include a passivation layer formed on the upper electrodes.
